(19) United States
(12) Patent Application Publication
(10) Pub. No.: US 2009/0053379 A1
(43) Pub. Date: Feb. 26, 2009

(54) CEREAL BRAN GRANULE AND FOOD PREPARED USING THE SAME

(75) Inventors: Yoko KIMURA, Amagasaki-shi (JP); Hisashi FUJII, Kyoto-shi (JP); Hirakazu ITOH, Inabe-shi (JP); Kenichi NIGAURI, Kobe-shi (JP)

Correspondence Address: BROWDY AND NEIMARK, P.L.L.C.;624 NINTH STREET, NW, SUITE 300, WASHINGTON, DC, 20001-5303, US

(73) Assignee: MITSUWA CO.LTD, Himeji-shi (JP)

(21) Appl. No.: 12/260,078

(22) Filed: Oct. 28, 2008

(30) Foreign Application Priority Data
Nov. 24, 2006 (JP) 2006-317736

(51) Int. Cl. A21D 13/00; A21D 13/08

(52) U.S. Cl. 426/560

(57) ABSTRACT

The aim of the present invention is to provide a novel food material which comprises cereal bran containing plenty of dietary fiber, does not harm the volume of bakery products and cakes, and gives good taste to them, even when it is added to the dough of bakery products such as bread and cakes. Another aim of the present invention is to provide a food, such as bakery products, i.e. bread and cakes, which is prepared by using the novel food material of the present invention. The aims are attained by providing cereal bran granule obtained by granulating powdery composition which comprises powder of cereal bran, and a food prepared by using the cereal bran granule.

### FIELD OF THE INVENTION

The present invention relates to cereal bran granule comprising plenty of insoluble and soluble dietary fiber which is a food material having health maintaining function, and a food prepared by using the same.

### BACKGROUND OF THE INVENTION

It is indicated that the Japanese in recent years are deficient in dietary fiber and that damages in health occur due to the deficiency. Water soluble dietary fiber has functions of suppressing rise of blood sugar level, decreasing cholesterol level in serum and decreasing neutral fat. Food and Drug Administration (FDA) in the United States recommends to take 3.0 g of water soluble dietary fiber of barley bran or oat bran a day for adult to prevent cardiac diseases. On the other hand, water insoluble dietary fiber is known well because of its stool improving function mainly. It is necessary to take both water soluble and insoluble dietary fiber in good balance.

While 20 to 25 g of dietary fiber in total a day is necessary, it is said that the current Japanese are about 5 g of dietary fiber short in average. It is considered that the Japanese in old days took water insoluble and water soluble dietary fiber in the ratio of 2 to 1, which is ideal balance.

A variety of foods, to which various dietary fibers are added, have been proposed to supply the deficiency of dietary fiber. For example, Japanese Patent Kokai Hei 2-227020 (JP 1990-227020 A1) proposes adding wheat bran, which comprises plenty of dietary fiber, into flour of high gluten content along with surface active agent having Hydrophile-Lipophile Balance (HBL) of 9 or higher. Japanese Patent Kokai 2001-045960 (JP 2001-045960 A1) proposes adding resistant dextrin, which is water soluble dietary fiber made from starch, into bakery products. Further, Japanese Patent Kokai 2002-306094 (JP 2002-306094 A1) proposes adding beta-glucan which is extracted and purified from barley or oat into processed foods. Among these foods, bakery products such as bread in particular are taken so frequently in daily life. When bakery products such as bread comprise relatively large amount of dietary fiber, they can be very excellent health maintaining foods because of their easiness to be taken.

However, cereal bran such as wheat bran, barley bran and oat bran, comprising plenty of dietary fiber, and other purified dietary fiber are usually commercialized in powder form and have disadvantages that, when they are added as they are into ordinary dough for bread or cakes, the bread or cakes obtained by baking the dough generally tend to be less expansive, to have closely packed less vacant crumb without softness, to be inferior in volume, and to be worse in taste in proportion to the amount of dietary fiber added to the dough.

That is to say, materials, such as resistant dextrin and beta-glucan, which comprise water soluble dietary fiber as main ingredients, and powder of cereal bran, such as oat bran and barley bran, which is rich in water soluble dietary fiber, have the disadvantages that, when they are added into dough of bread or cakes, the bread or cakes tend to expand insufficiently, to have hard, less vacant and closely packed crumb which lacks softness. On the other hand, powder of wheat bran which is rich in water insoluble dietary fiber has disadvantages that, when it is added into dough of bread or cakes, the baked bread or cakes, while not so serious as in the case of the above mentioned powder of oat bran or barley bran which are rich in water soluble dietary fiber, tend to be less expansive, more rough in mouth feeling, and worse in taste in proportion to the amount of dietary fiber added to the dough.

To eliminate the disadvantages, above mentioned Japanese Patent Kokai Hei 2-227020 (JP 1990-227020 A1) tries to give volume to the bread by using high protein content wheat flour which comprises 14 w/w % or higher of protein and surface active agent having Hydrophile-Lipophile Balance (HBL) of 9 or higher. However, wheat flour for bread containing 14 w/w % or higher of protein is a special one, and it is not advisable to use additives such as surface active agent in view of the recent tendency of consumer toward non-additives. Japanese Patent Kokai Shou 62-87061 (JP 1987-87061 A1) and Japanese Patent Kokai Hei 11-103800 (JP 1999-103800 A1) propose to make the particle size of cereal bran powder minute by pulverizing cereal bran finely to improve the disadvantage of rough feeling in mouth. However, it is quite troublesome to pulverize wheat bran to the particle size of 90 micron meter or lower as proposed in Japanese Patent Kokai Shou 62-87061 (JP 1987-87061 A1). Furthermore, fat in wheat bran has to be removed in order to pulverize wheat bran into the particle size of 50 micron meter or lower as proposed in Japanese Patent Kokai Hei 11-103800 (JP 1999-103800 A1). When fat is removed from the wheat bran, solvent used in removal process has to be fully eliminated from wheat bran, which is quite troublesome.

### DISCLOSURE OF THE INVENTION

The present invention was made to overcome the disadvantages of the prior art as above mentioned. The aim of the present invention is to provide a novel food material which comprises cereal bran containing plenty of dietary fiber, which does not harm the volume of bakery products and cakes, and which gives good taste to bakery products and cakes, even when it is added to the dough of bakery products such as bread and cakes. Another aim of the present invention is to provide a food, such as bakery products, i.e. bread and cakes, which is prepared using the novel food material of the present invention.

The present invention attains the aims by providing cereal bran granule obtained by granulating powdery composition which comprises powder of cereal bran, and a food prepared by using the cereal bran granule.

One, two or more kinds of cereal bran powder selected from the group consisting of wheat bran powder, oat bran powder and barley bran powder can be used in the present invention. Wheat bran contains up to 40 w/w % of dietary fiber, which is composed of about 3 w/w % of water soluble dietary fiber and 37 w/w % of water insoluble dietary fiber. Oat bran contains 26.5 w/w % of dietary fiber, a bit less than wheat bran, which is composed of 8.5 w/w % of water soluble dietary fiber and 18.0 w/w % of water insoluble dietary fiber (Japan Food Research Laboratories No. 206020347-001), and is good in balance of water soluble and water insoluble dietary fiber. Barley bran is generally rich in water soluble dietary fiber, while the content of dietary fiber in barley bran varies widely depending on the species. In the present invention, two or more kinds of powder of the cereal bran can be used in combination considering the amount and balance of dietary fiber contained in each kind of powder. Only one kind of cereal bran powder may be of course used.

Resistant dextrin which contains about 80 w/w % of water soluble dietary fiber and/or resistant starch which contains about 50 w/w % of water soluble dietary fiber can be added optionally to the cereal bran powder to adjust the proportion of water soluble dietary fiber to water insoluble dietary fiber in the cereal bran powder. The cereal bran powder thus prepared is granulated to form cereal bran granule of the present invention. Furthermore, gluten and/or starch can be added to the cereal bran powder before granulation if necessary to improve the texture of bakery products or cakes, which comprise the cereal bran granule prepared from said cereal bran powder.

Particle size (diameter) of the cereal bran granule of the present invention is preferably in the range of 0.5 mm to 10 mm, more preferably in the range of 1 mm to 7 mm. When the particle size is less than 0.5 mm, the merit of the cereal bran granule is not exhibited sufficiently. On the other hand, when the particle size is over 10 mm, the volume occupied by the cereal bran granule in dough or foods, into which the cereal bran granule is added, becomes too much for the dough or foods to hold its desirable shape, which is demerit.

Foods as referred to in the present invention mean all kinds of foods which can be prepared by using the cereal bran granule of the present invention. In particular, bakery products and cakes are the preferable examples of the foods. Bakery products and cakes mean all kinds of food products which are prepared by baking, frying or steaming up the dough comprising wheat flour and/or rice flour as main ingredients. For example, bread, steamed bread, cookies, cracker, biscuit, waffle, hot cake, doughnut, sponge cake, butter cake, yeast cake, rice cake, rice cracker, “manju” (a bun filled with a bean-jam), “chuka-manju” (a bun filled with meat flake or a bean-jam), are raised as examples. The cereal bran granule of the present invention is used by adding into the dough of the bakery products such as bread or cakes.

The cereal bran granule of the present invention contains plenty of dietary fiber and is granulated in an appropriate particle size. Due to this features, the cereal bran granule of the present invention does not harm the volume of bakery products or cakes, and does not give rough mouth feeling to them, even when the bakery products or the cakes are prepared using the dough into which the cereal bran granule of the present invention is added. In view of this, the bakery products and the cakes prepared by using the cereal bran granule of the present invention have good taste and make it possible for a person to take sufficient amount of dietary fiber through the foods that are frequently taken in daily life. This is quite excellent advantages. Furthermore, the cereal bran granule of the present invention has the advantages that the proportion of water soluble dietary fiber to water insoluble dietary fiber can be easily adjusted by changing the mixing ratio of several kinds of cereal bran powder and/or by mixing other powder comprising dietary fiber. The cereal bran granule of the present invention has further advantages that it can be produced easily and with low cost, because it is not necessary to pulverize cereal bran quite minutely, but is enough to pulverize cereal bran to the normal fine level in order to produce the cereal bran granule of the present invention from cereal bran powder with granulation. The foods prepared by using the cereal bran granule of the present invention contain relatively large amount of dietary fiber and have good taste.

In view of this, the foods of the present invention are very advantageous as health maintaining foods that can be taken in daily meals and can supply dietary fiber to a person who is deficient in it.

### BEST MODE FOR CARRYING OUT THE INVENTION

The cereal bran granule of the present invention is obtainable by granulating powder composition which comprises cereal bran powder. Cereal bran such as wheat bran, oat bran, or barley bran can be used as cereal bran. Cereal bran produced in foreign countries can be used as well as domestic one. The cereal bran may contain albumen. After having been sterilized with heat, the cereal bran is pulverized into powder to facilitate granulation. It is not necessary to pulverize cereal bran to quite fine level to prepare the cereal bran powder used in the present invention, but is enough to pulverize cereal bran into powder form that can be granulated with ordinary pulverizer. While there are no restrictions about particle size of the cereal bran powder, it is preferable to pulverize the cereal bran to the particle size of 2 mm or lower so as to facilitate the granulation.

Selecting from various kinds of cereal bran powder such as wheat bran powder, oat bran powder, or barley bran powder, only one kind of cereal bran powder can be used alone, or two or more kinds of cereal bran powder can be used in combination. As mentioned above, since the content of dietary fiber as well as the ratio of water soluble dietary fiber to water insoluble dietary fiber in cereal bran are different depending on the species of cereal, it is possible to adjust the content of dietary fiber and/or the proportion of water soluble dietary fiber to water insoluble dietary fiber comprised in the cereal bran granule, if necessary, by mixing appropriate two or more kinds of cereal bran powder.

In addition to the cereal bran powder, materials containing dietary fiber such as resistant dextrin and/or resistant starch can be added to the powder composition which comprises the cereal bran powder. As mentioned above, resistant dextrin contains about 80 w/w % of water soluble dietary fiber, and resistant starch contains about 50 w/w % of water soluble dietary fiber. It is therefore possible to change the content of dietary fiber and/or the ratio of water soluble dietary fiber to water insoluble dietary fiber comprised in the cereal bran granule by appropriately adding resistant dextrin and/or resistant starch to the powder composition. There are no restrictions about the percentage of resistant dextrin and/or resistant starch in the cereal bran granule. The amounts of resistant dextrin and/or resistant starch added to the powder composition which comprises the cereal bran powder may be determined according to desirable amount and/or desirable kinds of dietary fiber which should be comprised in the cereal bran granule.

Other than the cereal bran powder, gluten and/or starch can be added to the powder composition which comprises the cereal bran powder to control the texture of the foods prepared by using the cereal bran granule. There are no restrictions about the percentage of gluten and/or starch in the cereal bran granule. The amounts of gluten and/or starch added to the powder composition can be determined according to the texture that should be possessed by the foods prepared by using the cereal bran granule.

Other than the cereal bran powder, saccharides and/or sugar alcohols such as sucrose, maltose, trehalose, xylitol, seasonings such as salt, minerals such as calcium, iron, and vitamins such as vitamin C, vitamin E, can be added to the powder composition which comprises the cereal bran powder.

The powder composition comprising the cereal bran powder thus prepared is granulated with granulator. While any kinds of granulator may be used, single screw extruder or twin screw extruder is employed typically. While there are no restrictions with regard to the particle size of the cereal bran granule, the particle size (diameter) of the cereal bran granule is usually preferable in the range of 0.5 mm to 10 mm, and more preferably in the range of 1 mm to 7 mm. When the particle size of the granule is less than 0.5 mm, the merit of granulation may not be exhibited sufficiently because such particle size of less than 0.5 mm is not so differ from that of cereal bran powder. On the other hand, when the particle size is over 10 mm, while the cereal bran granule of such particle size still can be used, the volume of the cereal bran granule in the dough or the foods in which the cereal bran granule is comprised becomes too much for the dough or the foods to be shaped appropriately, which is demerit. When the particle size of the cereal bran granule is in the range of 1 mm to 7 mm, while depending on the kinds of foods, the volume occupied by the cereal bran granule in the dough is kept in an appropriate range and the dough can be shaped easily, which is preferable. Besides, the cereal bran granule having the particle size of in the range of 1 mm to 7 mm gives desirable mouth feeling to the foods products prepared by using the cereal bran granule, which is also preferable.

The cereal bran granule thus produced is usually used by being incorporated into the dough of bakery products such as bread or cakes. Since the cereal bran granule of the present invention is granulated in granule form, it disperses in the dough for bread or cakes in heterogeneous manner and makes it possible to produce the foods having good and variety of resistance to being chewed.

When the cereal bran granule is used, for example, in combination with wheat flour to prepare dough of bread, wheat flour of any class may be used. However, usually, it is preferable to use strong or semi-strong wheat flour for bread of the first class having the protein content of 12 w/w % or higher and ash content of 0.5 w/w % or lower. Medium and soft flour having the lower protein content are not preferable because they do not contain enough gluten and make producibility of bread worse. The ratio of the cereal bran granule to the wheat flour is, while depending on the amount and/or kinds comprised in the cereal bran granule, usually preferable in the range of “the cereal bran granule”:“the wheat flour”=0.1:9.9 to 4.0:6.0 in weight ratio, and more preferably in the range of “the cereal bran granule”:“the wheat flour”=2.0:8.0 in weight ratio.

The bread dough is typically prepared by mixing 100 parts by weight of strong or semi-strong wheat flour, 5 or more parts by weight of the cereal bran granule, about 60 parts by weight of water, 2 parts by weight of table salt, 2 parts by weight of yeast, 2 to 10 parts by weight of granulated sugar, 0.1 parts by weight of yeast food, and optionally about 2 parts by weight of defatted milk powder, and then by kneading the mixture to obtain the dough for bread. The cereal bran granule is preferably added in the later stage of the mixing process of the various materials because the cereal bran granule should keep its shape in the bread. Other materials, namely, wheat flour, water, yeast, yeast food, table salt, sugar, oils and fat, etc., are added in accordance with the ordinary manner. When the bread is produced by sponge dough method, it is of course preferable to add the cereal bran granule at the later stage of main kneading process. The dough for bread thus prepared and comprising the cereal bran granule is passed to fermentation process and baking process according to the ordinary bakery processes to produce the bread. Thus produced bread comprises relatively large amount of dietary fiber, and, in addition, has volume, as well as softness, excellent mouth feeling and taste, and is very useful for a person to take necessary amount of dietary fiber through the daily meals without any special efforts.

According to the inventors' research, when the ratio in weight of wheat flour to the cereal bran granule prepared by granulating the cereal bran powder is set to “wheat flour”:“the cereal bran granule”=8:2, then a slice of the bread (70 g) comprises about 3.3 g more of dietary fiber than a slice of ordinary bread. Therefore, a slice and half of the bread (105 g) can supply about 5 g more dietary fiber, which corresponds to the amount of the dietary fiber deficient to the average Japanese. Since an ordinary bread comprises 2.3 g of dietary fiber per 100 g (STANDARD TABLES OF FOOD COMPOSITION IN JAPAN, Fifth revised edition, 2000, issued by Resources Council, Science and Technology Agency, Japan), the amount of dietary fiber which a person can take from a slice and half of the bread is calculated to be 7 g or more in total putting together the dietary fiber comprised in ordinary bread inherently. In the meantime, there are no staple foods which allow us to take such large amount of dietary fiber. A person can take 0.8 g of dietary fiber per 100 g of ordinary Japanese noodle, 0.3 g of dietary fiber per 100 g of polished boiled rice, 1.4 g of dietary fiber per 100 g of unpolished boiled rice, and, as mentioned above, 2.3 g of dietary fiber per 100 g of ordinary bread (STANDARD TABLES OF FOOD COMPOSITION IN JAPAN, Fifth revised edition, 2000, issued by Resources Council, Science and Technology Agency, Japan). When the cereal bran granule produced by granulating oat bran powder is mixed with wheat flour in the ratio “wheat flour”:“the cereal bran granule”=8:2 in weight, a person can take about 1 g of water soluble dietary fiber from a slice and half of the bread, and can take 3.15 g more of dietary fiber than from a slice and half of ordinary bread putting together the amount of water insoluble dietary fiber. The cereal bran granule obtained by granulating barley bran powder also makes it possible for a person to take a large amount of dietary fiber.

When cakes are produced using the cereal bran granule of the present invention, the cereal bran granule of the present invention can be added into the mixture of ordinary dough composition to prepare the dough, and then the dough is baked or fried according to the usual manner to produce cakes.

The present invention is further explained in detail below based on Working Examples and Comparative Examples.

### WORKING EXAMPLE 1

Wheat bran was put into a roaster and heated keeping the temperature of the wheat bran at 130° C., for 20 minutes. Then the heated wheat bran was sent to pulverizer to obtain pulverized wheat bran with particle size of 200 micron meter or lower. The pulverized wheat bran was granulated using twin screw extruder and dried to obtain granulated wheat bran granule having particle size of 2 mm in diameter. 500 g of the wheat bran granule thus obtained was mixed with 2000 g of wheat flour, 1300 g of water, 40 g of yeast, 40 g of table salt, 100 g of sugar, 1 g of yeast food, 100 g of shortening to prepare dough for bread. After having taken 30 minutes of floor time, the dough for bread was divided into lumps of 240 g each. The lumps of dough were shaped and six of the shaped lumps were put in baking cans for open top bread, then fermented in final proofer at 35° C. for 60 minutes, and baked in an oven set to have upper temperature of 220° C. and lower temperature of 240° C. The open top bread thus baked was 17.4 cm in height, had the crumb with fine grain and thin elongated membrane of bubbles. The open top bread was full of volume and had an appearance with plural particles of the bran granule dispersed well and appropriately. When tasted, the open top bread gave good mouth feeling and good taste, because the particles of the bran granule having appropriate resistance to being chewed well dispersed in the soft crumb of the bread. Since the open top bread comprises the wheat bran granule, it contains a plenty of dietary fiber, and is excellent in mouth feeling and taste. The open top bread can be taken easily and is very useful for a person to take dietary fiber which tends to be deficient.

### WORKING EXAMPLE 2

Granulated oat bran granule having particle size of 5 mm in diameter was obtain in the same manner as in Working Example 1 except that oat bran was used in place of wheat bran. Open top bread was produced in the same manner as in Working Example 1 except that the oat bran granule was used in place of wheat bran granule. The open top bread thus baked was 17.1 cm in height, had the crumb with fine grain and thin elongated membrane of bubbles. The open top bread was full of volume, and had an appearance with plural particles of the bran granule dispersed well and appropriately. When tasted, the open top bread gave good mouth feeling full of variety and good taste similarly to the open top bread produced in Working Example 1, because the particles of the bran granule having appropriate resistance to being chewed well dispersed in the soft crumb of the bread. Since the open top bread comprises the oat bran granule, it contains a plenty of dietary fiber, and is excellent in mouth feeling and taste. The open top bread can be taken easily and is very useful for a person to take dietary fiber which tends to be deficient.

### WORKING EXAMPLE 3

800 g of soft wheat flour, 300 g of granulated sugar, 120 g of egg, and 500 g of butter were mixed in a mixer to prepare homogeneous dough. 200 g of the granulated wheat bran granule obtained in Working Example 1 was added to the dough and was lightly stirred to obtain dough for cookie. The dough was rested for one hour, then rolled out to 5 mm in thickness, cut out in a form of a disk with a diameter of 3 cm using a molder, and baked at 180° C. for 20 minutes to produce cookie. Thus baked cookie comprises particles of wheat bran granule and gave mouth feeling full of variety. The cookie contains a plenty of dietary fiber because it comprises the wheat bran granule, and has excellent mouth feeling and taste. The cookie can be taken easily and is very useful for a person to take dietary fiber which tends to be deficient.

### COMPARATIVE EXAMPLE 1

Open top bread was produced in the same manner as in Working Example 1 except that the wheat bran powder with particle size of 200 micron meter or lower obtained in Working Example 1 by pulverizing wheat bran was used in place of the wheat bran granule and that 1550 g of water was used to prepare the dough for bread. The open top bread thus produced was 16.0 cm in height, had the crumb with thick and not elongated membrane of bubbles, less volume, and wore pale brown as a whole. The open top bread was insufficient in softness when tasted and was not good in taste. The open top bread was inferior in mouth feeling and taste, and was not suitable for a health maintaining food which supplies the deficiency of dietary fiber, although it comprises wheat bran powder and therefore plenty of dietary fiber.

### COMPARATIVE EXAMPLE 2

Open top bread was produced in the same manner as in Working Example 1 except that the oat bran powder with particle size of 200 micron meter or lower obtained in Working Example 2 by pulverizing oat bran was used in place of the oat bran granule used in Working Example 2 and that 1550 g of water was used to prepare the dough for bread. The open top bread thus produced was 14.6 cm in height, had the crumb with thick and not elongated membrane of bubbles, wore pale brown as a whole, had weak appearance and was bad in so-called “oven spring”. The open top bread gave mouth feeling inferior to the open top bread produced in Comparative Example 1, and was dry, hard, and worse in taste. The open top bread was inferior in mouth feeling and taste, and was not suitable for a health maintaining food which supplies the deficiency of dietary fiber, although it comprises oat bran powder and therefore plenty of dietary fiber.

### INDUSTRIAL APPLICABILITY

As explained above, according to the cereal bran granule of the present invention, cereal bran such as wheat bran, oat bran and barley bran can be utilized thoroughly by being powderized and granulated, and foods which are rich in dietary fiber and excellent in taste and mouth feeling, such as bakery products and cakes, are easily produced. The cereal bran granule of the present invention makes it possible without making any special effort to take necessary amount of dietary fiber, which is deficient to the current Japanese, by taking the foods such as bakery products and cakes in daily life. The cereal bran granule of the present invention, as a novel food material containing plenty of dietary fiber, and the foods prepared by using the novel food material, i.e. the cereal bran granule of the present invention, as foods which can be taken in daily life without making any special effort and are excellent in taste and mouth feeling, both contribute much to maintaining health and are quite useful.

1. Cereal bran granule, which is produced by granulating powder composition comprising cereal bran powder.

2. A cereal bran granule of claim 1, wherein the cereal bran powder is one, two or more kinds of cereal bran powder selected from the group consisting of wheat bran powder, oat bran powder and barley bran powder.

3. A cereal bran granule of claims 1 or 2, wherein the powder composition comprising cereal bran powder further comprises one, two or more kinds of resistant dextrin, resistant starch, gluten, or starch.

4. A cereal bran granule of any one of claims 1 to 3, which has particle size in the range of 0.5 mm to 10 mm.

5. A food which is prepared by using a cereal bran granule according to any one of claims 1 to 4.

6. A food of claim 5, which is a bakery product or a cake.

7. A food of claims 5 or 6, which comprises cereal bran granule in an amount of 1 w/w % or more.
